(19) United States
(12) Patent Application Publication
(10) Pub. No.: US 2024/0295510 A1
(43) Pub. Date: Sep. 5, 2024

(54) MACHINE FOR THE COMPOSITE SCANNING OF OBJECTS

(71) Applicant: GILARDONI S.P.A., Milano (IT)

(72) Inventor: Davide Baratto, Milano (IT)

(21) Appl. No.: 18/572,333

(22) PCT Filed: Jun. 29, 2022
(86) PCT No.: PCT/IB2022/056038

§ 371 Date: Dec. 20, 2023

(30) Foreign Application Priority Data
Jun. 30, 2021 (IT) 102021000017234

(51) Int. Cl. G01N 23/046

(52) U.S. Cl. CPC G01N 23/046; G01N 2223/1016; G01N 2223/3306; G01N 2223/3308; G01N 2223/419

(57) ABSTRACT

Machine for the composite scanning of objects, comprising a booth (2) equipped with an opening (21) on a front wall that can be closed by a door, which booth (2) is internally lined with lead to prevent radiation from accidental exit from the booth (2) W) itself, wherein on one side wall (22) of the two internal side walls of said booth (2) there is at least one X-my source (31) which projects at least one beam of radiation in the direction of the opposite side wall (23) of the booth (2) where a receiving device (32) of said at least one beam of radiation is arranged, wherein on the base of the booth (2) there is a support plane (4) for the objects to be scanned, and wherein on the same side wall of the booth (2) where the X-my source (31) is located there is a surface scanning tool (5) of the objects placed on the support plane (4).

The present invention concerns a machine for the composite scanning of objects.

The industry is increasingly directing its efforts towards the search for programs that ensure product quality; in this context, digital radioscopy finds its ideal application, which, by allowing the radiological image to be obtained in real time, makes it possible to achieve the highest levels of productivity in the quality control of large batches of specimens. The direct and immediate view also allows to obtain timely information useful to production for the optimisation of the production process with evident and relevant advantages in terms of product quality and costs, waste reduction and economy of the entire production cycle.

In particular, X-ray machines are known to be used to check whether there may be defects in the structure inside the products, or if there is the presence of contaminants inside them. Radiogenic tubes are also used to carry out industrial checks on welds and search for fractures in metal parts subjected to stress that cannot otherwise be inspected.

During the reconstruction of the tomographic volume, it is possible to adjust the thresholds that identify the surfaces, but it is difficult to adapt them to all the complex shapes of the object to be analysed; it is also possible to orient the object appropriately and continuously in order to achieve the optimal incidence of all its critical parts and obtain a spatial view of the defects present.

X-ray machines of this type basically comprise a booth, having an access gate on one side that can be closed by means of a special sliding or hinged door which is advantageously transparent in order to have a view inside the machine, where on the base of said booth there is a rotary table on which the object to be analysed is positioned. The rotary table allows at least 360° rotation of the object so that it can be viewed from all its angles.

On a side wall of the machine, there is arranged the radiation source associated with movement means of the same capable of positioning the beam at a predetermined height and orienting it in the direction of the object with angles from −90+90 at most (−45+45) with respect to a vertical plane. The movement means are also provided with cantilever mechanisms, capable of moving the source towards the object, in particular horizontally and in the direction of the opposite wall of the booth in which the source itself is present.

On this wall opposite to the one presenting the source, there are receiving means of the X-ray beam that crosses the object provided with a translator that position it substantially in the most suitable position to receive the beam projected from the source in the opposite wall.

Such a machine is marketed by the same Applicant and named BOOTH XE-L.

The Applicant has observed that these machines are able to reconstruct the object in a detailed manner and faithful to the original, especially in its is internal parts, while the definition of the surface contour of the object itself is less precise.

Surface scanning tools (e.g. laser or structured light scanners) are tools capable of measuring the position of hundreds of thousands of points at very high speed in order to define the surface of the detected objects.

What is obtained is a very dense set of points usually referred to as a point cloud that can subsequently be processed with special software to define the dimensions of the objects, to give a 3D graphic representation thereof and to accurately describe, with vector drawings, the metric characteristics of what has been detected.

Therefore the combination of a detection carried out with a laser scanner (surface of the object) and one carried out with an X-ray source (internal parts of the object) and the subsequent processing of the images and data received results in a 3D reconstruction of an object that is more effective than the reconstruction carried out with the X-rays alone.

Patent KR101480968B1 describes an inspection apparatus and inspection method using X-ray computed tomography and laser surface scanning, and more specifically, an inspection apparatus comprising an X-ray scanning unit, a laser scanning unit and a radiation shielding unit. Depending on the apparatus, a more effective inspection of the interior and of the surface of an object can be expected. Furthermore, since the radiation shielding unit prevents malfunctioning of the laser detection unit caused by X-rays, a more accurate inspection result can be achieved.

The Applicant has noted that in the machines XE-EL of the same Applicant the internal wall of the booth that presents the X-ray radiation source, can also be used to insert a surface scanning tool such as a piece of equipment of the laser scanner type that integrates the scanning of objects carried out by X-rays. This type of equipment emits rays that fly in a straight line until they encounter something to hit. When they find it, they bounce and move back to the source itself.

The processing somehow (depending on the type of tool—time-of-flight or phase difference) allows the x,y,z coordinates (with respect to the emitter) of the hit points to be known in real time. This type of equipment is well placed on a single internal wall of a booth, as it does not need to have receiving devices placed in a different position from that of the X-ray emission source.

The present invention therefore aims to realise a machine for the composite scanning of objects that solves the above-mentioned drawbacks having the characteristics of the attached claim 1.

Further features of the invention are highlighted by the dependent claims. The features and advantages of the present invention will be more apparent from the following description, which is to be understood as exemplifying and not limiting, with reference to the appended schematic drawings, wherein:

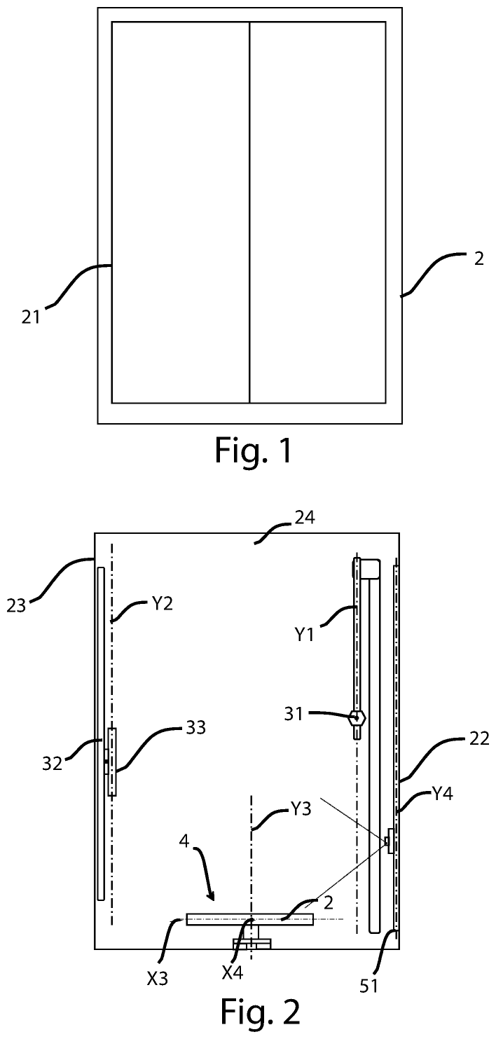

FIG. 1 is a front view of the machine according to the present invention with the booth access gate closed;

FIG. 2 is a front view of the machine according to the present invention without the front wall having the access gate;

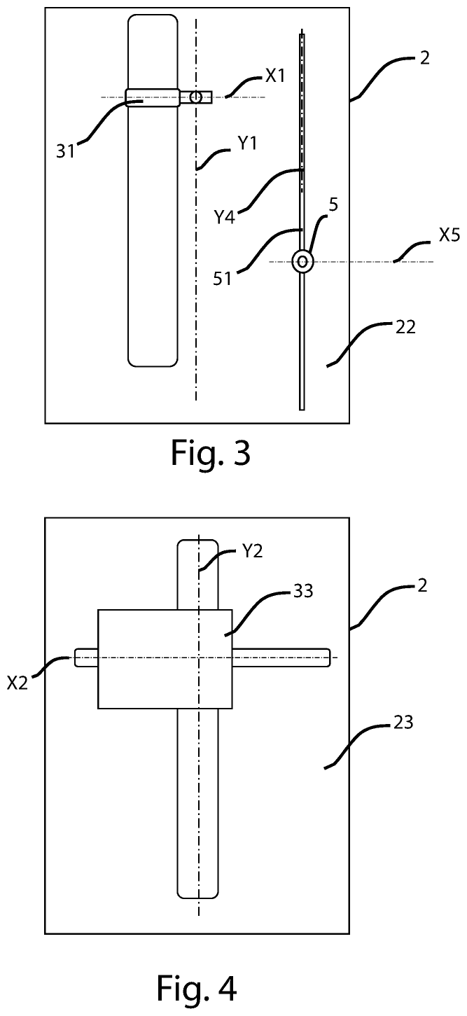

FIG. 3 is a view of an internal side wall of the machine;

FIG. 4 is a view of the internal side wall of the machine as opposed to that of FIG. 3.

With reference to the above-mentioned figures, the machine according to the present invention comprises a booth 2 equipped with an opening 21 on a frontal wall that can be closed by a door, e.g. a sliding door. The booth is internally lined with lead to prevent radiation, when the booth is in operating condition and an x-ray scan is performed, from preventing accidental exit of the same. Inside the booth on one 22 of the two side walls there is at least one X-ray source 31 which projects at least one beam of radiation in the direction of the opposite wall 23 where a receiving device 32 is arranged. This source is provided with a movement device capable of lifting the source along a first vertical axis Y1 and making the source itself, and therefore also the emitted beam rotate, around a first horizontal axis X1, substantially parallel to the wall 22.

This rotation can allow an inclination of the X-rays emitted by the source with respect to the horizontal advantageously comprised between −60° and +60°.

The receiving device 32 also comprises its movement device that allows the receiving area 33 to move vertically along a second axis Y2 and to move horizontally along a second axis X2 substantially parallel to the wall 22.

On the base of the booth there is a support plane 4 for the objects to be scanned. This plane comprises a rotary table 41 capable of rotating around a third vertical axis Y3. In addition, this plane comprises a translator 42 capable of moving the table along a third horizontal axis X3, and a fourth horizontal axis X4 (orthogonal to the third X3) in order to expose the objects to X-rays from all the necessary angles. In fact, the two movement devices (for source and receiver) and the support plane result in a seven-axis manipulator.

According to one aspect of the present invention on the same wall 22 where the X-ray source is placed, there is a tool for surface scanning 5 of the objects placed on the table 41.

This tool can be a laser device or a structured light scanner.

Such a tool comprises a manipulator 51 capable of moving a source of said tool along a fourth vertical axis Y4 and of rotating the source around a fifth horizontal axis X5, substantially parallel to the wall 22. This rotation can allow an inclination of the rays emitted by the source with respect to the horizontal advantageously comprised between −45° and +45, so as to “sweep” the object placed on the table 41 both from top to bottom, and from bottom to top.

If necessary, the manipulator can rotate the source by 90° so that the rays emitted by the source “sweep” the object placed on the table 41 both from left to right and from right to left.

The electronic processing unit of the machine receives the X-ray scanned images from the receiving device and the image of the surface of the object provided by the surface scanning tool. This image defines the contours of the object. By combining the two pieces of information, a better reconstruction of the object can be achieved than with the sheer X-ray scanning, where for rather complex objects the definition of the contours may be inaccurate, while the internal part of the objects themselves are very well defined.

The positioning of the surface scanning tool on the same wall as the X-ray emission source causes the surface scanning tool to be affected by the same.

1. Machine for the composite scanning of objects, comprising a booth (2) equipped with an opening (21) on a front wall that can be closed by a door, this booth is internally lined with lead to prevent radiation from preventing accidental exit from the booth itself, on one (22) of the two internal side walls of said booth there is at least one X-ray source (31) which projects at least one beam of radiation in the direction of the opposite wall (23) where a receiving device (32) of said beams is arranged, on the base of the booth there being a support plane (4) for the objects to be scanned, characterized in that on the same wall where the X-ray emission source is located there is a surface scanning tool (5) of the objects placed on the support plane (4).

2. Machine according to claim 1, wherein said tool is a laser scanning device or a structured light scanner.

3. Machine according to claim 1, wherein said X-ray source is provided with a movement device capable of lifting the source along a first vertical axis (Y1) and of making the source itself and therefore also the emitted beam rotate, around a first horizontal axis (X1), substantially parallel to the wall (22).

4. Machine according to claim 1, wherein the receiving device (32) comprises a movement device which allows the receiving area (33) to move vertically along a second axis (Y2) and to move horizontally along a second axis (X2) substantially parallel to the wall (22).

5. Machine according to claim 1, wherein the support plane (4) comprises a rotary table (41) capable of rotating around a third vertical axis (Y3) and a translator (42) capable of moving the table along a third horizontal axis (X3) and a fourth horizontal axis (X4) orthogonal to the third.

6. Machine according to claim 1, wherein said object surface scanning tool comprises a manipulator capable of moving the device vertically a fourth vertical axis (Y4) and of rotating the source itself around a fifth horizontal axis (X5), substantially parallel to the wall (22).

7. Machine according to claim 6, wherein said rotation allows an inclination of the rays emitted by the source with respect to the horizontal advantageously comprised between −45° and +45°.

8. Machine according to claim 1, comprising an electronic processing unit that receives the X-ray scanned images from the receiving device and the image of the object surface from the scanning tool defining the contours of the object, such unit by combining the two pieces of information performs a reconstruction of the object.
